(19) United States
(12) Patent Application Publication
(10) Pub. No.: US 2004/0004446 A1
(43) Pub. Date: Jan. 8, 2004

(54) Drive circuit for an led lighting apparatus

(76) Inventor: Hun-Huang Liu, Kuei-Shan Hsiang (TW)

Correspondence Address: DELLETT AND WALTERS, 310 S.W. FOURTH AVENUE, SUITE 1101, PORTLAND, OR, 97204, US

(21) Appl. No.: 10/189,864

(22) Filed: Jul. 5, 2002

(51) Int. Cl. H05B 37/02

(52) U.S. Cl. 315/224; 315/291

(57) ABSTRACT

A drive circuit for light-emitting diode (LED) lighting apparatus is disclosed. The power circuit that drives multiple interconnected light-emitting diode basically is a switching power supply and comprises a pulse width control IC, a pulse transformer and an output conversion circuit. The drive circuit provides the operating voltage for multiple light-emitting diodes. The pulse width control IC takes the output current from the output conversion circuit as feedback control signal, such that when the output current from the output conversion circuit increases, the pulse width control IC corrects the pulse width on the output to cause a decrease in voltage output to control the current output and to extend the service life of light-emitting diode.

### BACKGROUND OF THE INVENTION

1. Field of the Invention

The present invention relates to a drive circuit for a light-emitting diode (LED) lighting apparatus, in particular, a lighting apparatus using LEDs as a light source capable of achieving considerable power saving, extending the service life of the lighting apparatus and maintaining a constant current to drive LED illumination.

2. Description of Related Art

Using LEDs as a light source for lighting apparatuses is an inevitable trend for the future. Furthermore, an LED has the advantages of low power, low operating temperature and prolonged service life. In the past, LEDs were produced only in a few colors, such as red, green and amber, which precluded the development of LED lighting apparatuses for a wide range of applications. However, with the advent of blue and white LEDs, the application of LEDs is now virtually limitless. Use of large LED displays is becoming increasingly popular.

Although using LEDs as the light source to develop lighting apparatuses has been much discussed previously; there are still certain practical considerations that must be solved to achieve satisfactory quality. Although considerable improvements have been made with respect to the brightness of light-emitting diodes, using merely a few light-emitting diodes cannot provide adequate illumination for lighting purpose. If illumination is to be increased to meet the requirements for lighting, many more light-emitting diodes are needed. Then the real question is how to drive the numerous light-emitting diodes while still maintaining stable illumination without flicker.

### SUMMARY OF THE INVENTION

The main objective of the present invention is to provide a drive circuit capable of driving multiple light-emitting diodes simultaneously and maintaining illumination at a stable level.

The drive circuit in accordance with the present invention is basically a switching power supply comprising an input filter and rectifier circuit, a pulse transformer, an output conversion circuit and a feedback control loop. The input filter and rectifier circuit improves the electromagnetic compatibility, protects the light-emitting diodes from over-current, and converts input power from AC to DC. The pulse transformer is capable of passing high voltage pulses to the output conversion circuit through its primary winding and secondary winding. The pulse width control IC is capable of correcting the pulse width to cause a proportional decrease in voltage output from the output conversion circuit. The output conversion circuit is capable of maintaining voltage output and current flow to the light-emitting diodes at a constant level. The feedback control loop controls the current flow through the light-emitting diodes by taking the output current from the output conversion circuit as a feedback control signal.

Since the generation of heat in the process of turning on the light-emitting diodes lessens the forward voltage across the light-emitting diodes and increases current flow, the voltage output must be controlled by the output conversion circuit at a constant level to protect the light-emitting diodes from over-current. A constant current is achieved by means of a feedback control loop. The feedback control loop is composed of two parallel-connected resistors and a photo coupler. The two parallel resistors are connected between the output of the output conversion circuit and multiple light-emitting diodes. The input to the photo coupler is connected to the output of the output conversion circuit, and the output is connected between the second secondary winding of the pulse transformer and the feedback pin of the pulse width control IC.

In the drive circuit operation, a signal with a specific frequency is first output from the pulse width control IC, and the signal sensing the pulse transformer outputs a high voltage pulse. The output conversion circuit then turns on multiple light-emitting diodes. However, simultaneous heat emission in the diode illumination process causes a decrease in forward voltage across the light-emitting diodes and an increase in current flow through the light-emitting diodes.

The increase in current is detected by the feedback control loop that changes the voltage on the feedback pin of the pulse width control IC. The pulse width control IC thereby corrects the pulse width on the output pulse, which causes a proportional step down of output voltage from the output conversion circuit, thus achieving the objective of controlling the drive current through the light-emitting diodes. Since light-emitting diodes are current-driven components, a change in the voltage level does not affect the current through the light-emitting diodes. Therefore the brightness of the light-emitting diodes can be assured.

The features and structure of the present invention will be more clearly understood when taken in conjunction with the accompanying figures.

### BRIEF DESCRIPTION OF THE DRAWINGS

FIG. 1 is a circuit diagram of a drive circuit for a light-emitting diode (LED) lighting apparatus in accordance with the present invention;

FIG. 2 is an exploded perspective view of an LED lighting apparatus;

FIG. 3 is a perspective view of an LED lighting apparatus.

### DETAILED DESCRIPTION OF THE PREFERRED EMBODIMENT

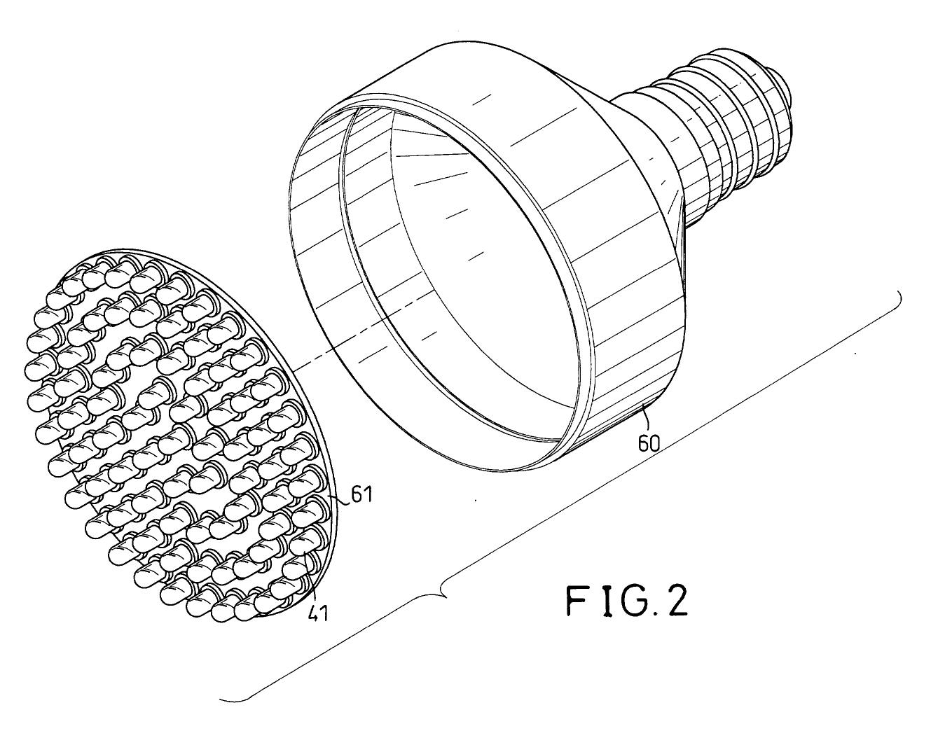

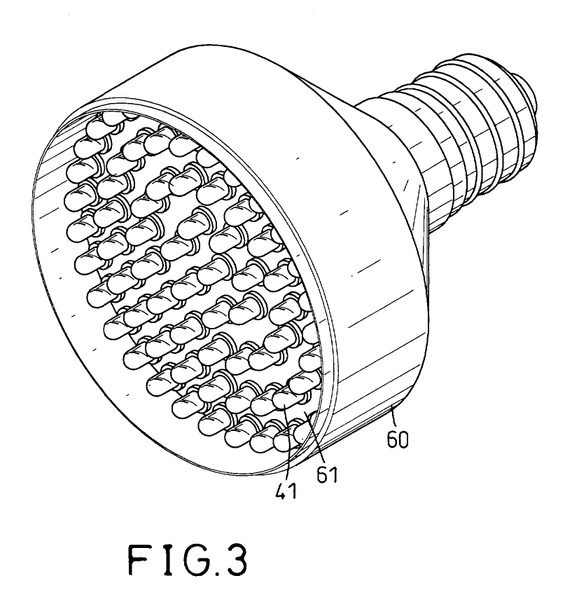

With reference to FIGS. 2 and 3, the drive circuit in accordance with the present invention is installed on a circuit board (61) that is mounted in a canopy type lamp holder (60). Multiple light-emitting diodes (42) are mounted in sockets (not shown) on the circuit board (61) in a matrix array or cellular arrangement. Each light-emitting diode (41) is electrically connected to the circuit board (61) and controlled by the drive circuit described below.

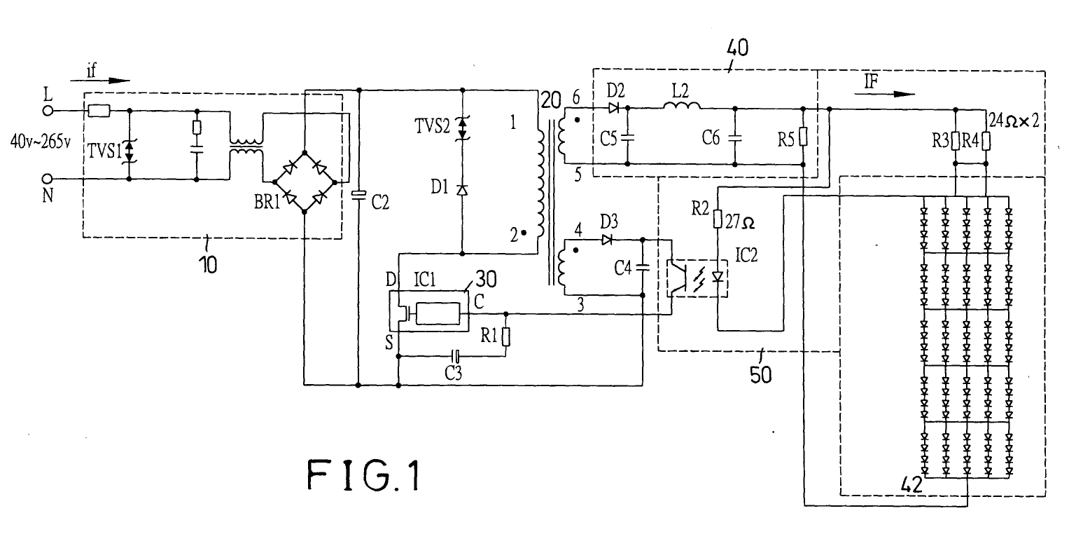

With reference to FIG. 1, the drive circuit in accordance with the invention is mainly a switching power supply and comprises an input filter and rectifier circuit (10), a pulse transformer (20), a pulse width control IC (30), an output conversion circuit (40) and a feedback control loop (50) in the basic circuitry.

The input filter and rectifier circuit (10) acts as an input filter and converts the input power from AC to DC.

The pulse transformer (20) has a primary winding (1-2), and a first secondary winding (5-6) and second secondary winding (3-4). One end (1) of the primary winding is connected to the output of the input filter and rectifier circuit (10).

The output of the pulse width control IC (30) is connected to the other end (2) of the primary winding on the pulse transformer (20).

The input of the output conversion circuit (40) is connected to the first secondary winding (5-6) on the pulse transformer (20), and the output to the matrix of light-emitting diodes (42).

The input of the feedback control loop (50) is connected to the output of the output conversion circuit (40), and the output is connected between the second secondary winding (3-4) on the pulse transformer (20) and the feedback pin on the pulse width control IC (30).

In actual operation, the drive circuit also behaves like a conventional switching power supply. A signal with a specific frequency is first output from the pulse width control IC (30) to the primary winding (1-2) on the pulse transformer (20), and it is sensed by the pulse transformer (20) by outputting a high voltage pulse on the first secondary winding (5-6). Through the output conversion circuit (40), the output current turns on the matrix of light-emitting diodes (42) simultaneously.

Since heat emission in the diode illumination process tends to lessen the forward voltage across the light-emitting diodes and increase current flow through the light-emitting diodes, the output from the output conversion circuit (40) must be maintained at a constant level to protect the light-emitting diodes from over-current and to extend their service life. Constant current operation is achieved by means of a feedback control loop (50).

The feedback control loop (50) is composed of two parallel resistors (R3, R4) and a photo coupler (IC2). The two parallel resistors (R3, R4) are connected between the output of the output conversion circuit (40) and the matrix of light-emitting diodes (42). One input of the photo coupler (IC2) is connected to the output of the output conversion circuit (40) through a resistor (R2). Another input is connected to the second secondary winding (3-4) on the pulse transformer (20) as a power source. The output is connected to a feedback pin (C) on the pulse width control IC (30).

According to the operating principles of the feedback control circuit (50), when multiple light-emitting diodes in the matrix of light-emitting diodes (42) generate heat in the turning on process, the rising ambient temperature causes the forward voltage across the light-emitting diodes (42) to drop, resulting in more current through the matrix of light-emitting diodes (42), and the breakover voltage on the photo diode (IC2) in the feedback control loop (50) is correspondingly increased. This increases the voltage on the feedback pin (C) of the pulse width control IC (30). The pulse width control IC (30) thereby reduces the pulse width by decreasing the duty cycle, resulting in lower voltage output from the output conversion circuit (40). Thus the current through the two parallel resistors (R3, R4) to the matrix of light-emitting diodes (42) can be controlled. Since light-emitting diodes are a current-driven components, current through the light-emitting diodes can be maintained at a constant level regardless of changes in output voltage, thus the illumination of the light-emitting diodes (42) is kept at stable level.

A control voltage mode can also be implemented on the feedback control loop (50) rather than the control current mode. However, the forward voltage decrease across the light-emitting diodes (42) will cause increased current, making the light-emitting diodes susceptible to over-current damage. Therefore, the current mode of operation is more suitable for the purpose of extending the service life of the light-emitting diodes.

Furthermore, the total current passing through the matrix of light-emitting diodes (42) is estimated to be about 93 mA based on the circuit design described above. It is possible to change the electrical impedance of resistors R2, R3, and R4 in the feedback control loop to meet the circuit requirement for specific types of light-emitting diode, so as to attain optimized amount of current and the desired level of illumination.

The foregoing illustration of the preferred embodiments in the present invention is intended to be illustrative only, under no circumstances should the scope of the present invention be so restricted.

What is claimed is:

1. A drive circuit for an LED lighting apparatus, which is mainly a switching power supply comprising:
an input filter and rectifier circuit adapted to be an input filter and to convert input power from AC to DC;
a pulse transformer having a primary winding, and a first secondary winding and a second secondary winding, wherein one end of the primary winding is connected to the input filter and rectifier circuit;
a pulse width control IC having the output terminal connected to the other end of the primary winding on the pulse transformer;
an output conversion circuit having the input connected to the first secondary winding on the pulse transformer, and the output to the light-emitting diodes; and
a feedback control loop such that the output from the output conversion circuit is fed back to the input of the pulse width control IC to cause constant output current.

2. A drive circuit for LED lighting apparatus as claimed in claim 1, wherein the structure of the feedback control loop is composed of two parallel-connected resistors and a photo coupler, wherein the two parallel resistors are connected between the output of the output conversion circuit and the light-emitting diodes; and the input of the photo coupler is connected to the output of the output conversion circuit, and the output connected between the second secondary winding on the pulse transformer and the feedback pin of the pulse width control IC

3. A drive circuit for LED lighting apparatus as claimed in claim 1, wherein multiple light-emitting diodes of an LED lighting apparatus are arranged on a common plane in cellular format.
